(19) United States
(12) Patent Application Publication
(10) Pub. No.: US 2010/0146073 A1
(43) Pub. Date: Jun. 10, 2010

(54) MOBILE DATA UPLOAD TO ENTERPRISE COMPUTER SYSTEMS

(76) Inventors: KERSTIN DITTMAR, Stuttgart (DE); Ingo Deck, Mannheim (DE); Dietrich Mayer-Ullmann, Ilvesheim (DE); Martin Schrepp, Hockenheim (DE); Susann Stieler, Heidelberg (DE)

Correspondence Address: SAP AG, 3410 HILLVIEW AVENUE, PALO ALTO, CA, 94304, US

(21) Appl. No.: 12/327,840

(22) Filed: Dec. 4, 2008

(51) Int. Cl. G06F 15/16; G06F 3/048

(52) U.S. Cl. 709/218; 715/764

(57) ABSTRACT

A method and a system for a mobile data upload to an enterprise computer system are described. The data is received at a mobile device. The mobile device operates in a particular context. A reference to an application object of the enterprise computer system is specified based on the context. The data is sent directly from the mobile device to the application object using the specified reference. The context of the mobile device could include the location of the mobile device, the performed task, the user habits, and other elements that are analyzed either by the mobile device or by the enterprise system.

### FIELD OF THE INVENTION

The field of the invention relates generally to electronic data processing and more particularly to upload data stored in a mobile device to enterprise computer systems.

### BACKGROUND OF THE INVENTION

Mobile device manufacture is among the most dynamic industries worldwide. In addition to their growing popularity, mobile devices are becoming more and more sophisticated, tapping the rapid development in hardware, software, and communication technologies. Such devices are already actively used for capturing, storing and exchanging large amount of data including texts, pictures, audio and video files, etc. Furthermore, there are a myriad of mobile devices with reasonable prices on the market able to run a wide range of complex applications. Consequently, the mobile devices are increasingly applied for providing electronic services in many business applications, especially in enterprise applications.

The mobile business workforce, such as sales representatives or service technicians, need access to enterprise data and enterprise applications in real time at virtually every location. The usability of the mobile devices is lower compared to the usability provided by a personal computer, for example. However, because of the growing capability, low price, small and lightweight design, and wide communication coverage, mobile devices have become very attractive for the mobile workforce. A large number of business processes could be rearranged to become more efficient and faster through the use of mobile devices.

The enterprise applications that provide services though mobile devices could be enhanced to analyze the context of the mobile device and to adjust the functionality accordingly. The context of a machine or a device is important in many aspects. Through context awareness, enterprise applications could achieve broader acceptance of the mobile devices in the enterprise or business applications. So far, context information, especially location information, is typically used in business-to-customers applications such as providing maps and lists of local service spots. The application of context awareness in typical enterprise applications, such as CRM applications or logistics applications, is still not addressed well.

For example, there are many business objects in a customer relationship management (CRM) enterprise application that would be more detailed and understandable if they have a photo attached. These objects include products, contacts, accounts, service orders, etc. Currently, tedious effort is required for a user to bring the photos into the CRM system. The user has to take a photo, transfer it to his local file system, upload the photo into the CRM application, and then assign it to a respective CRM object.

### SUMMARY OF THE INVENTION

A method and a system for a mobile data upload to an enterprise computer system are described. The data is received at a mobile device that operates in a particular context. Then, a reference to an application object of the enterprise computer system is specified based on the context. The data is sent directly from the mobile device to the application object using the specified reference. The context of the mobile device could include the location of the mobile device, the performed task, the user habits, and other elements that are analyzed either by the mobile device or by the enterprise system.

### BRIEF DESCRIPTION OF THE DRAWINGS

A better understanding of the present invention can be obtained from the following detailed description in conjunction with the figures of the accompanying drawings in which like references indicate similar elements. It should be noted that references to “an” or “one” embodiment in this disclosure are not necessarily to the same embodiment, and such references mean at least one.

FIG. 1 illustrates a block diagram of a system to provide mobile data upload to an enterprise computer system, according to one embodiment of the invention.

FIG. 2 illustrates a flow chart of a process to receive data at a mobile device and send it to a particular application object, according to one embodiment of the invention.

FIG. 3 illustrates a flow chart of a process to receive mobile data at an application object of an enterprise computer system, according to one embodiment of the invention.

### DETAILED DESCRIPTION

The notion of a context or context awareness for a device may be split in three general components: activity, environment, and self. The activity component describes a task a user is working on. This component focuses on the human using the devices and on her/his habits. The environment component describes the physical and social surroundings of the device. This includes a current location, the activities in the environment, and other extern properties like temperature or humidity. The self component contains the status of the device itself.

Location awareness is a subset of context awareness and plays an important role for enhancing the functionality of various mobile applications. For example, location awareness could be used for derivation of implicit context information belonging to a particular location. The context awareness indicates the location of a device and a user of the device. Different applications are already available to use the location information. An example is the variety of mobile applications that utilize Global Positioning System (GPS) navigation.

Location awareness may involve a physical location and a semantic location. The physical location specifies the location of an object based on a global coordinate system. The location could be provided with a set of coordinates (e.g. longitude and latitude) with a varying degree of precision. The semantic location specifies the position of an object within a larger context. For example, such a larger context could be a building or a single room or a vessel. Every context provides some additional information about a local environment and its resources.

The invention subject to this application provides a mobile user with the possibility to capture or receive data at his or her mobile device and upload it directly to an enterprise system. Additionally, based on the context of the mobile device, the data could be uploaded directly to a specific application object.

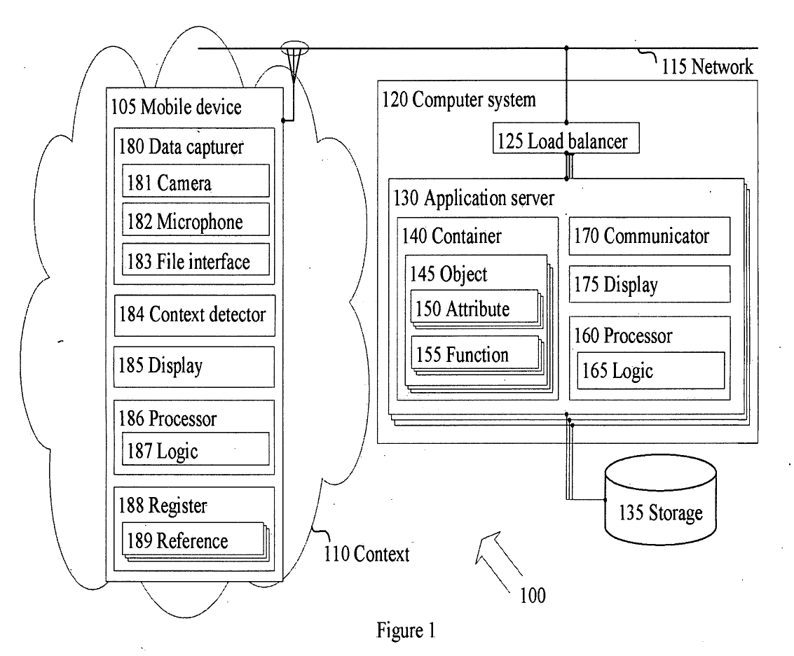

FIG. 1 is a block diagram of system 100 providing mobile data upload to an enterprise application running in an enterprise computer system. The illustrated system comprises a number of modules in accordance with an embodiment of the invention. Alternative embodiments of the invention would be obvious to one with ordinary skill in the art. System 100 comprises mobile device 105 running in context 110. Mobile device 105 communicates through network 115 with computer system 120.

Computer system 120 comprises at least one application server 130. When computer system 120 has a distributed architecture, it could comprise more than one application server 130. Application server 130 could run as a cluster in a distributed architecture and have similar structure. The different tasks performed by computer system 120 are routed to a particular application server 130 by load balancer 125 in accordance with predefined criteria, not limited to the current load of each application server 130. Application server 130 of computer system 120 could store common data on a separate storage 135.

Application server 130 could be built in compliance with any established standardized application server (AS) software technology; e.g. Java Enterprise Edition (Java EE) AS, .Net Framework, etc. Application server 130 runs a variety of applications to perform different tasks for automating one or more processes. For the purpose of this specification, it is assumed that application server 130 runs an enterprise application, e.g. CRM, human resource (HR) planning, supply chain management (SCM) system, etc. Computer system 120 could be established to automate the overall information processing in an enterprise.

Application server 130 comprises container 140 where a number of objects 145 are running. Container 140 provides an executing environment for the various enterprise applications and his functionality depends from the AS software technology standard that is applied. Application objects 145 in this document also represent instances of application objects. The object itself is the structure of a program or business element. Each object could have numerous instances that have the same structure, but different contents. For example, the names and addresses of all customers of an enterprise could be entered in matching number of instances of a “customer” object in a CRM system.

According to an embodiment, application objects 145 could be programming objects, business objects, or both. Programming objects are structured in accordance with the programming language used for the application development, while business objects resemble the structure of existing business entities. For example, the “customer” business object could resemble the structure of a business card in a customer relationship management (CRM) enterprise application.

Each object 145 is characterized by a number of attributes 150 and executes a number of functions 155, specific for the object. Attributes 150 contain data pertinent to the programming or business entity represented by the object. For each instance of the object, attributes 150 specify data to describe that particular instance. Using the example from the previous two paragraphs above, “customer” object has attributes that contain the name of the customer, the address, phone numbers, etc.

Further, application server 130 comprises processor 160 to execute logic 165 for identifying an application object instance among objects 145 based on the context 110. In one embodiment of the invention, processor 160 is running in the environment provided by container 140. Logic 165 could be coupled with functions 155 trough a specific container interface (not shown in FIG. 1), through an application programming interface (API), or other interface. When data is received from mobile device 105 at application server 130, the appropriate application object 145 is identified by logic 165 and executed by processor 160. The received information is assigned to the identified object 145 and kept in storage 135.

Application server 130 receives data from mobile device 105 at communicator 170. Communicator 170 could further carry on a number of other tasks. For example, communicator 170 could send requests to a third party system operator for identifying different components of context 110 (the components are not shown in FIG. 1). Subsequently, communicator could receive information about context 110. This information is used by logic 165 or container 140 to identify a respective application object 145. Communicator 170 could send at least one attribute 150 of object 145 to mobile device 105.

Application server 120 includes display module 175 to provide a graphical user interface (GUI) to the users of enterprise applications running on application server 130. Display module 175 renders, via the GUI, attributes 150 of application objects 145. Further, the graphical user interface could render the data received from mobile device 105. The GUI also allows the users to interact with the applications running on application server 130. Through the GUI, a user could access different functionalities provided by the applications. In the context of the current invention, for example, a user could search for data received from mobile device 105. Unassigned data could be assigned to a particular object, or, if the data is assigned, it could be reassigned to another application object 145. The user could navigate through the GUI by using hyperlinks, menus, or other means.

Display 175 provides, via the GUI, access to a set of functions or a tool for managing logic 165 for identifying application object 145 based on the received and analyzed data for context 110.

Returning to the photo upload example, display module 175 would visualize the photo when it is received at the application server 130. The received photo could be directly assigned to a CRM object 145, for example, to an application object containing data of an enterprise customer. The graphical user interface of display module 175 renders one or more attributes 150 of object 145. GUI provides means for navigating between screens that display attributes of different objects, and executing the pertinent application functions. Further, with the tools or means available through the GUI, a user could reassign the received photo to another object, or to assign it to one or more other objects. Via hyperlinks, the user could navigate to an overview page of the uploaded image that contains additional details, e.g. “Created by”, “Address”, “Assigned object”. Such details are received at communicator 170 from mobile device 105 or extracted from the running enterprise applications and their objects 145.

Mobile device 105 includes data capturer 180. This module includes channels for receiving, entering, or capturing data from a mobile device. For example, capturer comprises camera 181, microphone 182, File interface 183, etc. File interface 183 could be an interface supporting any existing technology or protocol for data exchange, for example, infra red interface or a Bluetooth™ interface. Through capturer 180, a user could load or receive data in his or her mobile device (e.g., making snapshots, recording an interview, receiving a business card or an electronic document, etc.).

According to an embodiment of the invention, mobile device 105 comprises context detector 184. The context detector 184 receives information regarding context elements of context 110. This allows mobile device 105 to create and maintain context awareness. The information regarding context elements could be communicated with computer system 120. Based on the context information an appropriate application object 145 could be identified at application server 130. In another embodiment, mobile device 105 does not include a module to detect or receive context related information. In such an implementation, context 110 is detected by a third party service provider and delivered to computer system 120 without involving mobile device 105.

When an application object from application objects 145 is identified, computer system 120 sends information for that object to mobile device 105. For the purposes of this document, the information about the object could be called a reference. However, the term reference should not be interpreted in the context or software programming or electronic data communication. In this document, the term “reference” has a general meaning that includes any kind of data that could be used for unique identification of one instance of an object among application objects 145. For example, such a reference is the data of an attribute of the object (e.g., name of a customer of a CRM object for managing customers).

Another module of mobile device 105 is display 185 that provides a graphical user interface (GUI) to a user of the mobile device. The GUI renders the data entered with the help of any of the modules of data capturer 180. Further, GUI also renders one or more references to the identified application objects among objects 145 based on the recognized elements of context 110. Through the GUI, the user of mobile device 105 confirms sending the data that is received at capturer 180 to computer system 120. The data could be sent to a specific object from objects 145 identified by a reference. The user confirms the sending by selecting or confirming the reference, visualized on display 185. Processor 186 is another module of mobile device 105 where is executed logic 187 to manage the process of sending the data received at capturer 180 to computer system 120.

In an embodiment of the invention, mobile device 105 comprises register 188 to store a number of references 189 identifying a number of instances of application objects 145. These references could be updated each time an element of context 110 changes, for example, when mobile device change place. Alternatively, a mobile device could store attributes or references for all objects 145 and, according to logic 187, only references appropriate to the context to be rendered on display 185. The data for objects 145 could be updated regularly or when a change in data of objects 145 in application server 130 occurs (e.g., when a new object is created, an existing object is changed or deleted).

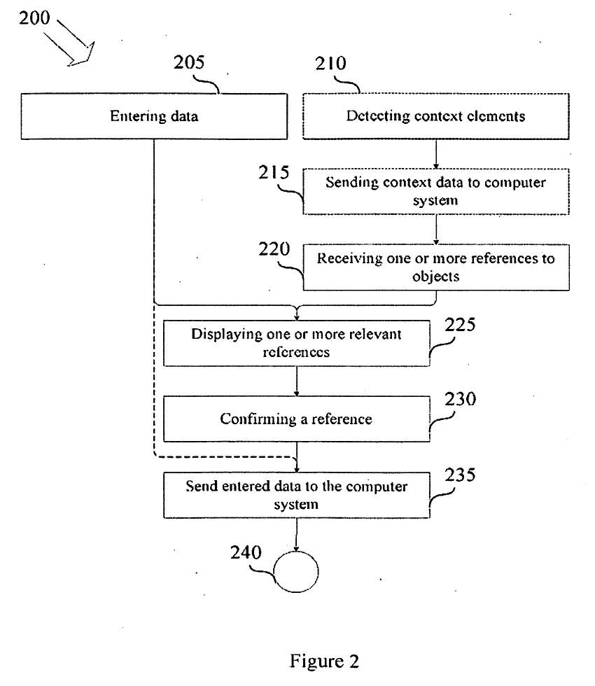

FIG. 2 is a flowchart of process 200 to receive data at a mobile device and send it to a particular application object of an enterprise computer system. According to an embodiment of the invention, the mobile device is coupled with an enterprise computer system and provides services as part of the executed enterprise application. At block 205, data is entered or captured in the mobile device. There are many different ways to enter data in a mobile device. For example, with a mobile device equipped with a camera, it is possible to take snapshots and store them in the device. In another example, the device could receive any type of electronic data from another device via cable or wireless connection, including electronic documents, short message service (SMS) messages, multimedia messaging service (MMS) messages, music files, etc. The examples for wireless connection include technologies such as infra-red communication, Bluetooth™ protocol, Global System for Mobile communication (GMS), etc.

At block 210, the mobile device detects or identifies elements of the context where the device operates. As explained above, the elements of the context could include information about the location of the device, about the habits or the performed task of the mobile device user, etc. Once the relevant context elements are detected, they are sent to the enterprise computer system at block 215. Blocks 210 and 215 are drawn with dash lines to indicate that in an alternative embodiment such process steps may not be present. In such a case the context elements could be detected or identified by a third party service provider, or directly by the enterprise computer system.

At block 220, one or more references to one or more instances of application objects are received. Application objects are the application building blocks of the enterprise computer system. Each application object instance represents program entity or business entity, according to the programming model and application architecture. Each reference provides data for an application object instance that is sufficient for identifying the instance. The mobile device could receive from the enterprise system references for all currently existing object instances at block 220. Alternatively, mobile device could receive only references for those object instances that are relevant to the current mobile device context. Blocks 210 through 220 could be executed recurrently on a specified interval, or at a specific event. Such an event could be, for example, change of a context element, new application object and instance, change of an existing object instance, etc.

One or more references to object instances, relevant to the context, are visualized on the display of the mobile device at block 225. The user of the mobile device could navigate through the list of references, when they are more than one, and could select one or more of them at block 230. After the appropriate reference or references is confirmed, the entered data is sent to the enterprise computer system at block 235. In an embodiment of the invention, the data could be sent without confirming a reference. In such a case, the data will not be assigned to a particular object instance in the enterprise application. This possibility is illustrated with a dashed arrow from block 205 to block 235 in process 200. Process 200 ends at block 240.

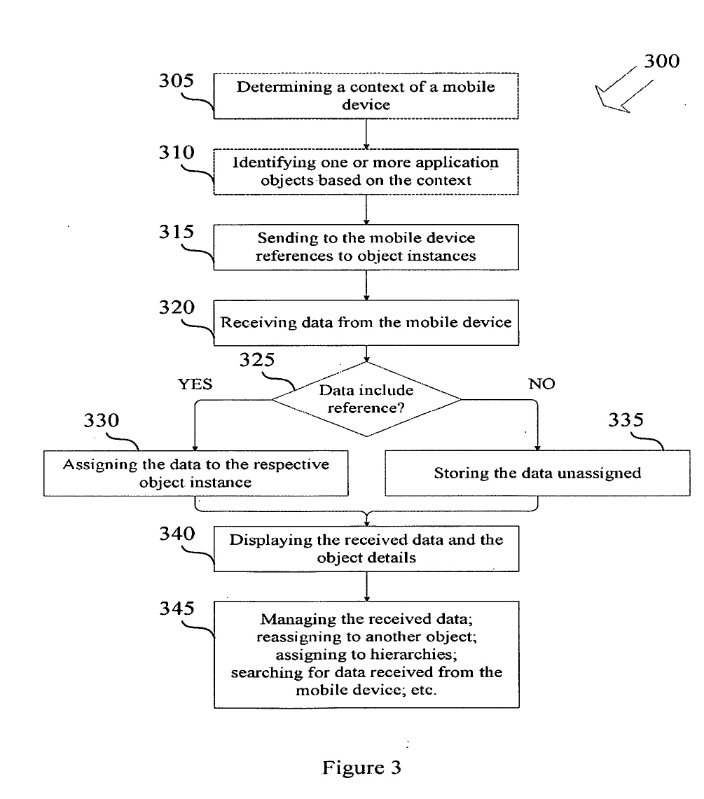

FIG. 3 is a flowchart of process 300 to receive data from a mobile device at a particular instance of an application object of an enterprise application, executed in an enterprise computer system. In accordance with an embodiment of the invention, there are many instances of the application objects that comprise information for different program or business entities. This information is stored in a number of attributes per each application object. At block 305, enterprise computer system determines the context of the mobile device. Information about the context could be received from the mobile device, from a third party service provider, or could be generated within the enterprise computer system.

The information about the context is analyzed and, at block 310, enterprise application identifies one or more application objects relevant to that context. Blocks 305 and 310 are illustrated with dashed lines because they are optional. In an embodiment of the invention, context data could be used only by the mobile device or by a third party service provider (e.g., mobile phone network operator, global location system (GPS) operator, etc). In such a case, enterprise computer system does not analyze the context of the mobile device.

At block 315, the enterprise computer system sends references to application object instances to the mobile device. Depending on whether the context is analyzed by the enterprise computer system, references to different groups of instances of application objects are sent. When the enterprise system receives context data and one or more instances of application objects are identified based on the context data, only references to those instances are sent to the mobile device.

At block 320, enterprise computer system receives data from the mobile device. At block 325, enterprise application checks whether the received data includes reference to one or more instances of application objects. If such a reference or references are received, at block 330, the data is assigned to the respective object instance or instances. However, if the received data doesn't comprise any references, then the data is stored in the enterprise application unassigned at block 335.

Later on, a user of the enterprise application could visualize the received data at block 340. If the data is assigned to an object, different attributes of the particular object instance could be also displayed. For example, if a photo is received and assigned to a customer object instance in a CRM application, the name, address, and many other data for the customer could be displayed together with the assigned photo in the CRM application GUI. When unassigned, the received data is displayed in a specific place or screen in the enterprise application. From there, a user could manually assign it to one or more application objects.

Enterprise application provides its users with various functions through the GUI. At block 345, a user could use these functions to manage the received data in the context of the relevant application objects and the goals of the enterprise applications. For example, the user could search for received data, using specific criteria, assign unassigned data to one or more application objects, reassign assigned data to another application object, or assign the received data within a hierarchy as a tree structure.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Reference throughout this specification to “one embodiment” or “an embodiment” means that a particular feature, structure or characteristic described in connection with the embodiment is included in at least embodiment of the invention. Thus, the appearance of the phrases “in one embodiment” or “in an embodiment” in various places throughout this specification are not necessarily all referring to the same embodiment. Furthermore, the particular features, structures or characteristics may be combined in any suitable manner in one or more embodiments.

What is claimed is:

1. A computerized method comprising:
receiving data at a mobile device;
specifying a reference to an application object of a computer system based on a context of the mobile device; and
sending the data to the application object of the computer system together with the reference.

2. The method of claim 1, wherein specifying the reference comprises:
receiving one or more attributes of the application object.

3. The method of claim 2 further comprises:
identifying the context of the mobile device; and
sending information about the context to the computer system.

4. The method of claim 1, wherein specifying the reference comprises:
identifying the context of the mobile device; and
selecting the reference from a plurality of references stored in the mobile device based on the context.

5. The method of claim 1 wherein specifying the reference comprises:
rendering on a graphical user interface (GUI) of the mobile device one or more references to one or more application objects of the computer system; and
confirming a reference through the GUI.

6. The method of claim 1, wherein the context comprises a component selected from a group comprising
a characteristic of one of an application task and a user habit,
an environment characteristic of one of a physical surrounding and a social surrounding of the mobile device, and
a status of one of the mobile device or of the computer system.

7. The method of claim 4, wherein the environment characteristic component of the context comprises a current location of the mobile device.

8. A computerized method comprising:
identifying a context of a mobile device in a computer system;
identifying an application object of the computer system based on the context of the mobile device;
receiving data from the mobile device; and
assigning the received data to the application object.

9. The method of claim 8, wherein identifying the context of the mobile device comprises analyzing information regarding a context component.

10. The method of claim 9, wherein the context component is selected from a group comprising
a characteristic of one of an application task and a user habit,
an environment characteristic of one of a physical surrounding and a social surrounding of the mobile device, and
a status of one of the mobile device or of the computer system.

11. The method of claim 10, wherein the environment characteristic component of the context comprises a current location of the mobile device.

12. The method of claim 8, wherein identifying the application object further comprises:
sending one or more attributes of the application object to the mobile device.

13. A system comprising:
an enterprise computer system;
a plurality of application objects running on the enterprise computer system as part of an enterprise application;
a context; and
a mobile device operable in the context in communication with the enterprise computer system to enter and send data to an application object from the plurality of application objects, the application object identified based on the context.

14. The system of claim 13, wherein the enterprise computer system comprises:
a container to hold the plurality of the application objects, each application object specified by a plurality of attributes;
a processor to execute a logic for identifying an application object from the plurality of application objects based on the context; and
a communicator to receive data from a mobile device and to assign the data to the identified application object.

15. The method of claim 14 further comprises:
a display module to provide a user with a graphical user interface (GUI) to access one or more functionalities selected from a group comprising
a view of a plurality of attributes of the application object,
a view of the data received from the mobile device
a plurality of functions to manage the received data, and
a GUI tool to define the logic for identifying the application object.

16. The system of claim 13, wherein the context comprises at least one component selected from a group comprising
a characteristic of one of an application task and a user habit,
an environment characteristic of one of a physical surrounding and a social surrounding of the mobile device, and
a status of one of the mobile device or of the enterprise computer system.

17. The system of claim 13, wherein the mobile device comprises at least one module selected from a group of modules comprising
a camera to capture visual data,
a microphone to record sounds, and
a file interface to receive electronic data.

18. The system of claim 13, wherein the mobile device comprises a context detector to receive one or more of the context components.

19. The system of claim 13, wherein the mobile device comprises:
a display module to provide a graphical user interface to
visualize entered data,
visualize a reference to the application object selected based on the context, and
provide a user with access to functions to send the data to the application object.

20. The system of claim 13, wherein the mobile device comprises:
a processor to execute a logic for send the entered data to the identified application object; and
a register to store one or more references to one or more application objects.
